(19) United States
(12) Patent Application Publication
(10) Pub. No.: US 2004/0249600 A1
(43) Pub. Date: Dec. 9, 2004

(54) Apparatus and methods of measuring a thermodynamic potential of a limited physical space characterized by a series of symmetry states

(76) Inventors: William A. Tiller, Payson, AZ (US); Walter E. Dibble JR., Payson, AZ (US)

Correspondence Address: TIM TINGKANG XIA, MORRIS, MANNING & MARTIN, LLP, 1600 ATLANTA FINANCIAL CENTER, 3343 PEACHTREE ROAD, N.E., ATLANTA, GA, 30326-1044, US

(21) Appl. No.: 10/453,710

(22) Filed: Jun. 3, 2003

(51) Int. Cl. G01K 1/00

(52) U.S. Cl. 702/130

(57) ABSTRACT

An apparatus and methods for measuring a thermodynamic potential of a limited physical space associated with a change in symmetry, wherein the limited physical space is characterized by a series of symmetry states having a ground symmetry state and at least one higher symmetry state. In one embodiment of the present invention, the method includes the step of transforming the limited physical space from the ground symmetry state to a higher symmetry state to cause the thermodynamic potential of the limited physical space to change from a first value to a second value. In another embodiment, the ground symmetry state is characterized by a U(1) EM Gauge symmetry, the thermodynamic potential Ψ is in the form of a proton magnetoelectrochemical potential, and the at least one higher symmetry state is characterized by an SU(2) symmetry.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention generally relates to apparatus and methods of measuring a thermodynamic potential of a limited physical space, and in particular to apparatus and methods of registering proton magnetoelectrochemical potential departure of a limited physical space due to a change in its symmetry state.

Certain embodiments of the present invention comprise an apparatus and methods of changing a thermodynamic potential of a limited physical space, wherein the limited physical space is characterized by a series of symmetry states having a ground symmetry state and at least one higher symmetry state. In one embodiment, the limited physical space is transformed from the ground symmetry state to a higher symmetry state to cause the thermodynamic potential of the limited physical space to change from a first value to a second value, which can be detected or measured.

### BACKGROUND OF THE INVENTION

Most people including scientists may never give the concept of electromagnetic (EM) gauge symmetry much thought, although they may know that the macroscopic properties of materials are almost completely determined by their electric and magnetic behavior. If the topic ever comes up in conversation between colleagues, it is generally considered to be in the domain of interest of particle physicists or relativity theorists. However, perhaps they might remember that it may enter the concept of the “Big Bang” theory, a cosmological theory that the universe began in a state of compression to infinite density and has been expanding since some particular instant that marked the origin of the universe, in an important way. They might recall that a short time after the initiation event, and before to after quarks form in the incredibly hot “fireball”, the universe evolves to successively lower thermodynamic free energy states via step by step changes in gauge symmetry, eventually passing through a SU(2) gauge symmetry state on its way to a U(1) gauge symmetry state, which, as discussed in more detail infra, is often referred to as the U(1) EM gauge symmetry state. Thereafter, the free energy of the U(1) gauge symmetry state continues to be lowered by a set of phase transitions, familiar to people skilled in the art, from plasma phase to gas phase then to liquid phase and then to solid phase as cooling continues. From the foregoing, one might deduce that, if one could raise the EM gauge symmetry state associated with an environment such as a laboratory, the properties of materials in that environment would change. In fact, they should be EM gauge symmetry state specific. The challenge is how to change the gauge symmetry state of a limited physical space and identify a measurable physical property associated with the change.

Thus, among other things, there is a need to develop new and improved apparatus and methods of changing the gauge symmetry state of a limited physical space, and apparatus and methods of measuring same accordingly.

### SUMMARY OF THE INVENTION

In one aspect, the present invention relates to an apparatus for measuring a thermodynamic potential Ψ of a limited physical space, wherein the limited physical space is characterized by a series of symmetry states having a ground symmetry state and at least one higher symmetry state.

In one embodiment, the apparatus includes a container that is at least partially filled with a liquid and placed within the limited physical space, wherein liquid is characterized by a parameter related to the hydrogen-ion activity, pH. The apparatus further includes a reference electrode with an input end and an output end and a measurement electrode with an input end and an output end, wherein the input end of the reference electrode and the input end of the measurement electrode are placed in the liquid for measuring the electric potential between the reference electrode and the measurement electrode, E_{measured}, as a function of time, from which the pH of the liquid as a function of time can be obtained. The apparatus also includes a microprocessor that is operatively coupled to the output end of the reference electrode and the output end of the measurement electrode, respectively, for receiving and processing the measured potential to obtain the change in the thermodynamic potential Ψ of the limited physical space. Moreover, the apparatus includes a power supply that is operatively coupled to the reference electrode, the measurement electrode, and the microprocessor, respectively, for supplying power to those devices. Furthermore, the apparatus includes a temperature measuring sensor for measuring temperature, T, of the liquid as a function of time. The apparatus may further include means for calibrating the reference electrode and the measurement electrode with at least two pH buffer solutions. The apparatus additionally may have a display device that can be operatively coupled at least to the microprocessor and the power supply, respectively, for displaying the measured results, data, related and unrelated images, and the like.

In one embodiment, the microprocessor performs the step of obtaining the change in the thermodynamic potential Ψ of the limited physical space, ΔΨ_{H}_{⁺}, from a relation having the form of:

ΔΨ_{H}_{⁺}=|e|E(1−|N|),

wherein e is electron charge, E is a potential function between the reference electrode and the measurement electrode with the form of

E=S(pH−7)((T+273.15)/298.15)

wherein E is in the unit of millivolts, T is in the unit of ° C., and N is an Nernst parameter with the form of

$$N = \frac{S}{E} ( p H - 7 ) ( \frac{T + 273.15}{298.15} ) .$$

The electrode slope S is determined from a relation having the form of:

S=dE_{measured}/dpH.

The Nernst parameter, N, has a value of unity for the limited physical space when it is at its ground symmetry state. The Nernst parameter, N, has a value of non-unity for the limited physical space when it is at its at least one higher symmetry state.

The ground symmetry state is characterized by a U(1) EM Gauge symmetry. The thermodynamic potential Ψ is in the form of a proton magnetoelectrochemical potential. The at least one higher symmetry state is characterized by a symmetry that is not a U(1) EM Gauge symmetry. In one embodiment, the at least one higher symmetry state is characterized by an SU(2) symmetry. The at least one higher symmetry state in general is characterized by an SU(n) symmetry, where n=2, 3, . . . , M+1, M being an integer.

The container can have various types of geometry. For example, in one embodiment, the container cross-sectionally is cylindrical. The container cross-sectionally can also be circular, square, triangular, or the like. Additionally, the liquid can be chosen from various types of fluids. For example, in one embodiment, the liquid is water. Other types of liquids such as water additional with additives may also be utilized to practice the present invention. Furthermore, gels and solid state ionic conductors may also be utilized to practice the present invention.

The limited physical space comprises a space substantially confined in three dimensions. The confined space comprises the interior space confined by a stationary structure. The stationary structure includes any and all man-made structures from temperatory to permanent buildings, private home to apartment complex, business establishment to manufacturing factories, sports facilities to art displays, and the like. The stationary structure may also include nature structures such as cave, cavern, tunnel and the like. The confined space also comprises the interior space confined by a structure that is capable of being stationary or in motion, which includes any and all man made vehicles such as automobiles, bus, train, ship, air plane, submarine, space shuttle, and the like.

In another aspect, the present invention relates to a method for changing a thermodynamic potential of a limited physical space, wherein the limited physical space is characterized by a series of symmetry states having a ground symmetry state and at least one higher symmetry state. In one embodiment, the method has the step of transforming the limited physical space from the ground symmetry state to a higher symmetry state to cause the thermodynamic potential of the limited physical space to change from a first value to a second value. The step of transforming includes the step of conditioning the limited physical space with an information coded radiation that is capable of causing the symmetry state of the limited physical space to change. Various types of radiation can be utilized to practice the present invention. For example, the information coded radiation may comprise a magnetic field signal generated from a magnet. Or, the information coded radiation may comprise an electric field signal generated from an electrical signal generator. The strength of the radiation can be adjusted. The radiation can be static or dynamic (i.e., with a time-dependent amplitude).

The method further includes the steps of maintaining the limited physical space at the higher symmetry state with the second value of the thermodynamic potential, and monitoring response of an object in the limited physical space at the higher symmetry state so as to provide feedback to the maintaining step, wherein the object in the limited physical space comprises at least one of a biological object and a non-biological object. Examples of the biological object include human beings, animals, living cells, plants, and the like. Examples of the non-biological object include anything that is not a biological object such as solid materials like metals, liquid materials like water, and vapor materials such as air.

In a further aspect, the present invention relates to an apparatus for changing a thermodynamic potential of a limited physical space, wherein the limited physical space is characterized by a series of symmetry states having a ground symmetry state and at least one higher symmetry state. In one embodiment, the apparatus includes means for transforming the limited physical space from the ground symmetry state to a higher symmetry state to cause the thermodynamic potential of the limited physical space to change from a first value to a second value.

In one embodiment, the transforming means comprises means for conditioning the limited physical space with an information coded radiation that is capable of causing the symmetry state of the limited physical space to change.

The apparatus further includes means for maintaining the limited physical space at the higher symmetry state with the second value of the thermodynamic potential and means for monitoring response of an object in the limited physical space at the higher symmetry state so as to provide feedback to the maintaining means.

In yet another aspect, the present invention relates to a method for measuring a thermodynamic potential Ψ of a limited physical space, wherein the limited physical space is characterized by a series of symmetry states having a ground symmetry state with a corresponding first value and at least one higher symmetry state with a corresponding second value. In one embodiment, the method comprises the steps of placing a container at least partially filled with a liquid within the limited physical space, wherein liquid is characterized by a parameter related to the hydrogen-ion activity, pH, inserting a reference electrode and a measurement electrode into the liquid, measuring the potential between the reference electrode and the measurement electrode, E_{measured}, as a function of time, measuring the pH of the liquid as a function of time, and measuring temperature, T, of the liquid as a function of time.

The method further includes the step of determining the electrode slope, S, for the liquid. Moreover, the step of determining may include the step of calculating 0 from a relation having the form of: S=dE_{measured}/dpH.

Additionally, the method includes the steps of introducing a potential function between the reference electrode and the measurement electrode, E, having the form of

E=S(pH−7)((T+273.15)/298.15),

wherein T is in the unit of ° C., and E is in the unit of millivolts, introducing an Nernst parameter, N, having the form of

$$N = \frac{S}{E} ( p H - 7 ) ( \frac{T + 273.15}{298.15} ) ,$$

and obtaining the change in the thermodynamic potential Ψ of the limited physical space, ΔΨ_{H}_{⁺}, from a relation having the form of:

ΔΨ_{H}_{⁺}=|e|E(1−|N|),

wherein e is electron charge. The method may further include the step of calibrating the reference electrode and the measurement electrode with at least two pH buffer solutions.

In a further aspect, the present invention relates to an apparatus for measuring a thermodynamic potential Ψ of a limited physical space, wherein the limited physical space is characterized by a series of symmetry states having a ground symmetry state with a corresponding first value and at least one higher symmetry state with a corresponding second value. In one embodiment, the apparatus comprises a container at least partially filled with a liquid placed within the limited physical space, wherein liquid is characterized by a parameter related to the hydrogen-ion activity, pH, a reference electrode and a measurement electrode placed in the liquid for measuring the potential between the reference electrode and the measurement electrode, E_{measured}, as a function of time, from which the pH of the liquid as a function of time can be obtained, and means for measuring temperature, T, of the liquid as a function of time.

The apparatus further includes means for determining the electrode slope, S, for the liquid, wherein the electrode slope S is determined from a relation having the form of:

S=dE_{measured}/dPH.

Additionally, the apparatus includes means for obtaining the change in the thermodynamic potential Ψ of the limited physical space, ΔΨ_{H}_{⁺}, from a relation having the form of:

ΔΨ_{H}_{⁺}=|e|E(1−|N|),

wherein e is electron charge, E is a potential function between the reference electrode and the measurement electrode when the environment is in the ground state, the U(1) EM symmetry state, with the form of

E=S(pH−7)((T+273.15)/298.15),

wherein E is in the unit of millivolts, T is in the unit of ° C., and N is an Nernst parameter, in any EM symmetry state, with the form of

$$N = \frac{S}{E} ( p H - 7 ) ( \frac{T + 273.15}{298.15} ) .$$

The apparatus may further include means for calibrating the reference electrode and the measurement electrode with at least two pH buffer solutions.

In one embodiment, the means for measuring temperature comprises a temperature measuring sensor such as a thermometer, and the means for obtaining the change in the thermodynamic potential Ψ of the limited physical space comprises a microprocessor. Additionally, the apparatus may further include a power supply that is operatively coupled to the reference electrode, the measurement electrode, and the microprocessor, respectively. A display device such as a computer terminal with a GUI (graphic user interface) that is operatively coupled at least to the microprocessor and the power supply, respectively, may also be utilized to practice the present invention.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

FIG. 1A schematically shows an experimental apparatus that can be used to test changes in gauge symmetry state due to a DC magnet placed under a water vessel with either the N-pole or the S-pole of the DC magnet axially and vertically aligned according to one embodiment of the present invention.

FIG. 1B schematically shows pH changes with time for pure water for both N-pole up and S-pole up axially aligned DC magnetic fields at 100 and 500 gauss, respectively, from Minnesota experiment sites according to one embodiment of the present invention when the EM symmetry state is different than the U(1) ground state.

FIG. 2 shows an experimental set up according to one embodiment of the present invention.

FIG. 3 shows dependence of a pH electrode source voltage on pH at 25° C. according to the Nernst relation for an ideal electrode with a slope efficiency of 100%.

FIG. 4A shows pH and Nemst-parameter (N) as a function of time, respectively, with fitted curves, wherein calculated pH is based on equilibrium between pure water and air as a function of measured water temperature for the U(1) ground state.

FIG. 4B shows N as a function of 1/E for a particular lab station at the P₅ site according to one embodiment of the present invention.

FIG. 4C shows ΔΨ_{H+} as a function of time at the P₇ site for the specific dates shown in year 2002 to year 2003 according to one embodiment of the present invention.

FIG. 5A shows values of N for a series of time periods following the installation of devices that raise the EM Gauge state at the site BB according to one embodiment of the present invention.

FIG. 5B shows values of Ψ_{H+} for a series of time periods following the installation of devices that raise the EM Gauge state at the site B_{B} according to one embodiment of the present invention.

FIG. 6 shows schematically the thermodynamic free energy change ΔG, from the ground symmetry state, U(1), as the degree of locale conditioning increases according to one embodiment of the present invention.

FIG. 7A shows pH as a function of time for the period of kinesiological treatments plus the prior 21 days before treatments according to one embodiment of the present invention.

FIG. 7B shows pH as a function of time for the period of kinesiological treatments plus the day before the treatments according to one embodiment of the present invention.

FIG. 8 shows schematically several interactive elements that may be involved in any human exchange according to one embodiment of the present invention.

### DETAILED DESCRIPTION OF THE INVENTION

Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Additionally, some terms used in this specification are more specifically defined below.

### Definitions

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using underlining, italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms may be provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “about” or “approximately” shall generally mean within 20 percent, preferably within 10 percent, and more preferably within 5 percent of a given value or range. Numerical quantities given herein are approximate, meaning that the term “about” or “approximately” can be inferred if not expressly stated.

As used herein, “Electromagnetic Gauge Symmetry” shall generally mean a characteristic state of a physical system related to the conservation of electric charge. People are generally familiar with symmetries that are geometrical in appearance, like the hexagonal (6-fold) symmetry of a snowflake or 4-fold symmetry of a cube. The charge symmetry of electric materials is non-geometric in that, for an ensemble of electric dipoles when the individual charges are suddenly reversed in sign, the energy of the ensemble as a whole is unchanged (“invariant”) so the forces also remain unchanged. The same type of behavior occurs for magnetic dipoles and electromagnetic fields in general. The character of the symmetry that makes Maxwell's theory of electromagnetism (EM) a Gauge theory is that the electric field is invariant with respect to the addition or subtraction of an arbitrary overall electric potential. A related symmetry can be demonstrated for the phase of an electron wave in the quantum theory of electrons since any phase angle can be added to or subtracted from the electron field and the results of all experiments will remain invariant. This is the essential ingredient found in the Electromagnetic Gauge symmetry or U(1) Gauge symmetry. Further discussion and description of the term “Electromagnetic Gauge Symmetry” can be found in the references 1 and 2 cited in the References List.

Conventional physical reality is in the U(1) EM Gauge symmetry state where materials include electric monopole, electric dipole and magnetic dipole constructed substances, Maxwell's equations of EM apply, the governing algebra is Abelian and the vacuum space between the fundamental particles comprising atoms and molecules is isotropic. A higher EM Gauge symmetry state is the SU(2) symmetry state where both electric and magnetic monopoles coexist, the equations of electromagnetism are non-Maxwellian and the algebra is non-Abelian. It is also very likely that the vacuum space within and between atoms and molecules is both partially ordered and non-isotropic.

Measurable Electric, Magnetic and Electromagnetic Forces for the U(1) State:

Ions, molecules, thermodynamically stable clusters of molecules and colloidal particles in solution, in the presence of environmental electric, E, and/or magnetic, H, fields, are subjected to unique forces resulting in unique motions in such fields. For electrical ions of valence z, the electrophoresis force causes the ion to move along DC electric field lines towards the oppositely charged electrode. For uniform AC electric fields, it merely oscillates back and forth along the field lines with no net displacement over time. For a neutral body, the E-field induces an electric dipole in the body. For a uniform field, either DC or AC, no net force develops on the body; however, for a non-uniform DC or AC E-field, a dielectrophoresis force develops on the body causing it to migrate towards the highest field regions of the medium. Likewise, for a neutral magnetic body, an H-field induces a magnetic dipole in the body and, for a uniform field (AC or DC) no net force develops on the body. However, for a non-uniform DC or AC H-field, a diamagnetophoresis force develops on the body causing it to migrate towards the highest field regions of the solution. For symmetry reasons, one uses the term diamagnetophoresis rather than the more commonly used term, magnetophoresis, to describe this case.

In quantitative terms, these three forces are given by

Fₑₚ=z|e|E (1a)

$$\begin{matrix}{F}_{dep} = \frac{3 {ϵ}_{1}}{2} υ {K}_{e} ∇ {\underline{E}}^{2} ; {K}_{e} = \frac{{ϵ}_{2} - {ϵ}_{1}}{{ϵ}_{2} + {ϵ}_{1}} & ( 1 b ) \\ {F}_{dmp} = \frac{3 {\hat{μ}}_{1}}{2} υ {K}_{m} ∇ {\underline{H}}^{2} ; {K}_{m} = \frac{{\hat{μ}}_{2} - {\hat{μ}}_{1}}{{\hat{μ}}_{2} + {\hat{μ}}_{1}} & ( 1 c )\end{matrix}$$

Here, F is force and the subscripts “ep”, “dep” and “dmp” represent, respectively, electrophoresis, dielectrophoresis and diamagnetophoresis. Also, here, |e| is the absolute magnitude of the electronic charge, z is the valence, ν is the body volume, K is the Claussius-Mossotti function and ∇ is the Del vector (divergence operator) while ε₂,ε₁,\hat{μ}₂ and \hat{μ}₁ are the electric permittivity of the body and the medium, respectively, plus the magnetic permeability of the body and the medium, respectively. There is no corresponding magnetophoresis force, Fₘₚ, because magnetic monopole charges do not exist in the U(1) symmetry state. Further discussion and description of the terms “Electric, Magnetic, and Electromagnetic Forces” can be found in the references 3 and 4 cited in the References List in addition to what is set forth above.

Atomic and Molecular Thermodynamic Potentials: In thermodynamics, for a system with m species, one of the most important quantities is the Gibbs free energy, G(P,T,cⱼ), in terms of the extrinsic variables P (pressure), T (temperature) and cⱼ (concentration of j-species for j=0, 1, 2, . . . , m) of the system. An important derivative quantity is the neutral species chemical potential for the j-component defined as

$${μ}_{j} = {( \frac{\partial G}{\partial {c}_{j}} )}_{P , T , {c}_{k} ( k \neq j )} = {μ}_{0 j} + k T ln {a}_{j} \qquad ( 2 a )$$

Here, aⱼ=yⱼcⱼ is the thermodynamic activity of the j-species and yⱼ is called the activity coefficient of j, k=Boltzmann's constant and μ₀ⱼ is the standard state chemical potential for the j-species. In this regard, one can incorporate the AC (alternating current) E and H energy storage, Δμ₀ⱼ, into the μ₀ⱼ term where

$$Δ {μ}_{0 j} = - \frac{{\hat{υ}}_{j}}{2} \frac{ⅆ}{ⅆ {c}_{j}} \{ ϵ {\underline{E}}^{2} + \hat{μ} {\underline{H}}^{2} \} \qquad ( 2 b )$$

Here, \hat{ν}ⱼ is the molal volume of j. For ionic species rather than neutral species, one uses the electrochemical potential, nⱼ, defined as

ηⱼ=μⱼ+zⱼ|e|V, (2c)

where V is the electric potential (voltage).

The foregoing paragraph applies to a system at the U(1) EM Gauge symmetry level or state. If the system is somehow at an EM Gauge symmetry level between the U(1) state and the SU(2) state, to define the operating potential function one must account for possible changes in the basic coherence level of the vacuum (denoting it as Δμ₀ⱼ) and for the effective magnetic monopole image charge, m_{eff}*, that bleeds through into measurements (denoting it as m_{eff}*ΔΓ, where ΔΓ is the change in the magnetic potential associated with the change in the EM Gauge symmetry state). Thus, one can now define a magnetoelectrochemical potential Ψⱼ for the j-species as

Ψⱼ=ηⱼΔμ₀ⱼ*+Δ(Δμ₀ⱼ)+m_{eff}*ΔΓ, (3a)

where

$$Δ ( Δ {μ}_{0 j} ) = - \frac{1}{2} \frac{ⅆ}{ⅆ {c}_{j}} \{ {\underline{E}}^{2} [ Δ ( {\hat{υ}}_{j} ϵ ) ] + {\underline{H}}^{2} [ Δ ( {\hat{υ}}_{j} \hat{μ} ) ] \} . \qquad ( 3 b )$$

Further discussion and description of the term “Thermodynamic Potential” can be found in the references 5, 6, 7 and 8 cited in the References List.

Subtle Energies: The four fundamental forces of gravity, electromagnetism, the long range nuclear force and the short range nuclear force lead to all the energies acknowledged to exist in conventional physics. As used herein, subtle energies are none of these and are defined as all being energies of the vacuum state. Here, the use of the word “subtle” does not mean weak but rather elusive and difficult to nail down, largely because current measurement instrumentation cannot register these energies directly but only indirectly via EM correlates. Further discussion and description of the term “Subtle Energies” can be found in the references 10, 11 and 12 cited in the References List.

Two Levels of Physical Substance: de Broglie's concept of the particle/pilot wave aspect of fundamental particles became a cornerstone of quantum mechanics. Expansion of this concept points to physical substance having two distinct levels of expression: (1) coarse particulate, electric monopole type substance and (2) fine information wave, magnetic monopole-generated substance. The latter falls in the category of subtle energies and resides at the vacuum level of physical reality. Further discussion and description of the de Broglie's concept can be found in the reference 11 cited in the References List.

Kinesiology: This technique utilizes a type of biofeedback from subconscious muscle responses to detect specific “stressors” within the body of a human being. The technique uses manual monitoring of specific muscles, which may either “lock” and hold strong or “unlock” and give, to determine balance or imbalances of stressors not only within the muscle systems themselves, but also within interfacing subconscious body systems. These systems include not only the generally recognized autonomic and proprioceptive feedback of the nervous system, but also the subconscious emotional and mental processes underlying human feelings and thought. More importantly, according to the present invention, the subconscious muscle system also interfaces with the subtle energy system of the body, the chakra-nadi system of the Yogis and the acupuncture meridian system of Chinese medicine. Further discussion and description of the term “Kinesiology” can be found in the references 13 through 15 cited in the References List.

As used herein, the term “limited physical space” means a space that is substantially confined in three dimensions. The term “confined space” means an interior space that is at least partially confined by a stationary structure. The stationary structure includes any and all man-made structures from temperatory to permanent buildings, private home to apartment complex, business establishment to manufacturing factories, sports facilities to art displays, and the like. The stationary structure may include nature structures such as cave, cavern, and the like. The confined space also comprises the interior space confined by a structure that is capable of being stationary or in motion, which includes any and all man made vehicles such as automobiles, bus, train, ship, air plane, submarine, space shuttle, and the like. The confined space can have exposure to the space outside the structure; but that exposure can be controlled.

### Overview of the Invention

In one aspect, the present invention relates to an apparatus and methods for changing a thermodynamic potential of a limited physical space, wherein the limited physical space is characterized by a series of symmetry states having a ground symmetry state and at least one higher symmetry state.

More specifically, as an example, a reproducible procedure for changing or raising the EM gauge symmetry state of laboratory space has been developed. This has been observed at four sites (the first group of sites) within about 1000 feet of each other by the inventors and at three other sites (the second group of sites) at distances from about 500 to about 1500 miles from these four sites. In the second group, two of the sites utilized independent investigators who followed the specific protocols as discussed in more details in the reference 10 cited in the Reference List.

In one embodiment, the procedure developed and used for raising a limited physical space, here a laboratory, to a higher EM gauge symmetry state involves utilization of a specially processed electronic device to be turned on in the physical space for a period of time of about 3 to 4 months so as to “condition” the physical space to this new symmetry state. Among other things, by following this procedure the inventors have accomplished the following:

1. Raised the pH of purified water by one full pH unit with no chemical additions (measurement uncertainty in the range of about 0.01 pH unit);

2. Reduced the pH of purified water by one full pH unit with no chemical additions;

3. Increased the in vitro thermodynamic activity of a specific liver enzyme, alkaline phosphatase (ALP) by about 25% with p<0.001 from statistical analysis of the data; and

4. Increased the in vivo ATP/ADP ratio in the cells of developing fruit fly larvae so that they become significantly more fit and thus exhibit reduced larval development time to the adult fly stage (by about 25% with p<0.001).

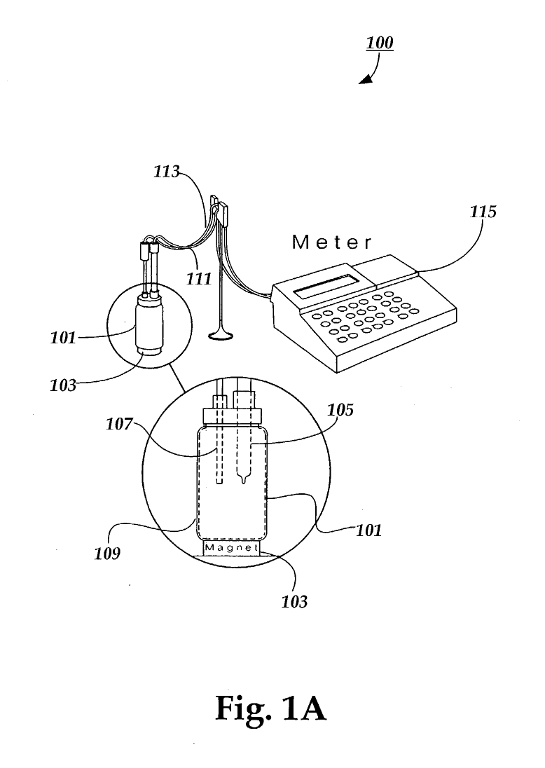

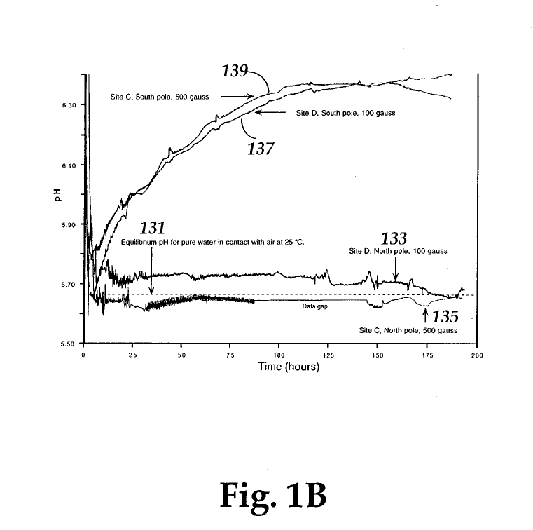

Among other things, one experimental result indicating a raising or changing of the EM gauge symmetry state comes from a DC magnetic field polarity result on the pH of purified water. As shown in FIG. 1A, according to one embodiment of the present invention, experimental set up 100 includes a vessel 101, containing purified water 109, a magnet 103, and pH-measurement sensors 105, 107, which are coupled to a meter 115 for data collection, monitoring and processing through links 111, 113, respectively. In operation, a round disk-shaped DC magnet 103 is placed under a cylindrical pH-measurement vessel 101 for about 3 days with one pole facing upwards (N or S) and then simply turn the magnet over for the next about 3 days of continuous measurement. An ThermoOrion® pH meter made by Thermo Electron Corporation, 500 Cummings Center, Beverly, Mass. 01915-6199, was chosen as meter 115, which has a central processor unit (CPU) for collecting and processing data. In a “conditioned” space one obtains a first result, which is shown in FIG. 1B. In FIG. 1B, curve 131 gives equilibrium pH for U(1) ground state pure water in contact with air at 25° C., which shows no changes with time, curve 133 shows pH changes with time for N-pole up axially aligned DC magnetic field at 100 gauss at one experimental site D, curve 135 shows pH changes with time for N-pole up axially aligned DC magnetic field at 500 gauss at one experimental site C, curves 137, 139 show the same as curves 133, 135 but for S-pole up axially aligned DC magnetic fields, respectively. However, in an “unconditioned” space, the normal U(1) EM gauge symmetry space, one expects ΔpH=pH(S)−pH(N)=0 as one would theoretically expect because the conventional magnetic force is proportional to ∇H² and thus no polarity effect should be observed. One theory is that only some type of magnetic monopole effect, leaking through from the SU(2) gauge symmetry level, may lead to such a DC magnetic field polarity effect.

More recently, in yet another embodiment of the present invention, some anomalous behavior was observed in the Nernst factor of pH electrodes measuring the pH-time profile of purified water at several simultaneously monitored stations in the Payson laboratory, one of the facilities where the inventors made their discoveries. These electrodes exhibited non-Nernstian behavior. Subsequent theoretical analysis of pH-electrode behavior to be expected in an approximate SU(2) EM gauge symmetry state showed how such non-Nernstian behavior might be understood from a thermodynamic perspective.

For (1) EM gauge state electrolyte solutions, where pH is being measured potentiometrically using a pH-electrode, the basic thermodynamic process involved is one of equilibration of H⁺ species between two points in the system via equating the electrochemical potential of H⁺, η_{H}_{⁺}, at these two points. Since ηH_{⁺} is given by

η_{H}_{⁺}=μ_{0,H}+kTln α_{H}+|e|V, (4)

where μ₀ is the standard state chemical potential, a is the thermodynamic activity (hydrogen-ion concentration in pure water) and V is the electrical potential. Equilibration is between a general measurement point and a 25° C., unit activity point, which is chosen as a reference state or the standard state. Here, the gravitational, plus AC electric and magnetic field terms plus the earth's DC magnetic field term may be, for convenience, included in the μ₀ term. Thus equilibration yields

$$V = {V}_{0} - \frac{k T}{\vert e \vert} ln {a}_{{H}^{+}} , \qquad ( 5 )$$

where V₀ is the potential at the standard state. Converting to a per mole basis and using the standard notation by substituting V with E, Equation 5 can be written as

$${E}_{measured} = {E}_{0} - \frac{2.303 RT}{n F} log {a}_{{H}^{+}} , \qquad ( 6 )$$

where F is the Faraday constant (23.1 kcal/volt). Here, E_{measured} is the measured potential of the sensing pH electrode (volts), E₀ is related to the potential of the reference electrode, (2.3RT/nF) is called the Nernst factor and log a_{H}_{⁺} is the pH. The Nernst factor includes the Gas Law constant, R, the Faraday constant, F, the temperature in degrees Kelvin, T, and the charge on the ion, n, which is 1 in this case. The electrode slope is an experimental measure of the Nernst factor and, at 25° C., is −59.16 mV/pH unit for the ideal electrode.

The experimental determination of the Nernst factor or electrode slope, S=dE_{measured}/dpH, requires calibrating the pH electrode using at least two pH buffer solutions. Most of the uncertainty in the ultimate pH measurement arises from the uncertainty in the pH of these buffers (±0.01 pH unit depending on pH and manufacturer). When, for example, meter 115 or the ThermoOrion® pH meter detects the sensing membrane signal, the reference signal and the temperature signal, the CPU of the ThermoOrion® pH meter calculates the pH via Equation 6 for an ideal electrode wherein the value of E_{measured}=0 at pH=7. The equation ThermoOrion® pH meter uses to calculate E at other pH values is

E=S(pH−7)((T+273.15)/298.15) (7)

where T is in ° C. and E is in millivolts. From this relation, at constant T, using the calibration value of S yields a change in pH whenever any variation in E is detected. Thus, for a physical space with a U(1) EM Gauge symmetry state, a new parameter, denoted here as the Nernst-parameter, N, can be introduced as

$$N = \frac{S}{E} ( p H - 7 ) ( \frac{T + 273.15}{298.15} ) . \qquad ( 8 )$$

Note that N should equal unity in U(1) Gauge space and experience shows that it does.

Following an exactly similar theoretical procedure for a higher EM Gauge symmetry space than the U(1) Gauge space but replacing the electrochemical potential for H⁺ with the magnetoelectrochemical potential, Ψ_{H}_{⁺}, one obtains the following formula for |N|,

$$\vert N \vert = 1 - \frac{Δ {Ψ}_{{H}^{+}}}{\vert e \vert E} . \qquad ( 9 )$$

Thus, it is deviations of |N| from unity in either the positive or negative direction that indicate the EM Gauge symmetry state has been changed. The magnitude of that change, ΔΨ_{H}_{⁺}, is given by

ΔΨ_{H}=|e|E(1−|N|). (10)

If ΔΨH_{H}_{⁺}<0, one must assume from Equation 3a that Δμ₀ⱼ*+Δ(Δμ₀ⱼ)+m_{eff}*ΔΓ<0, and the reverse, i.e., Δμ₀ⱼ*+Δ(Δμₒⱼ)+m_{eff}*ΔΓ>0, if ΔΨ_{H}_{⁺}>0.

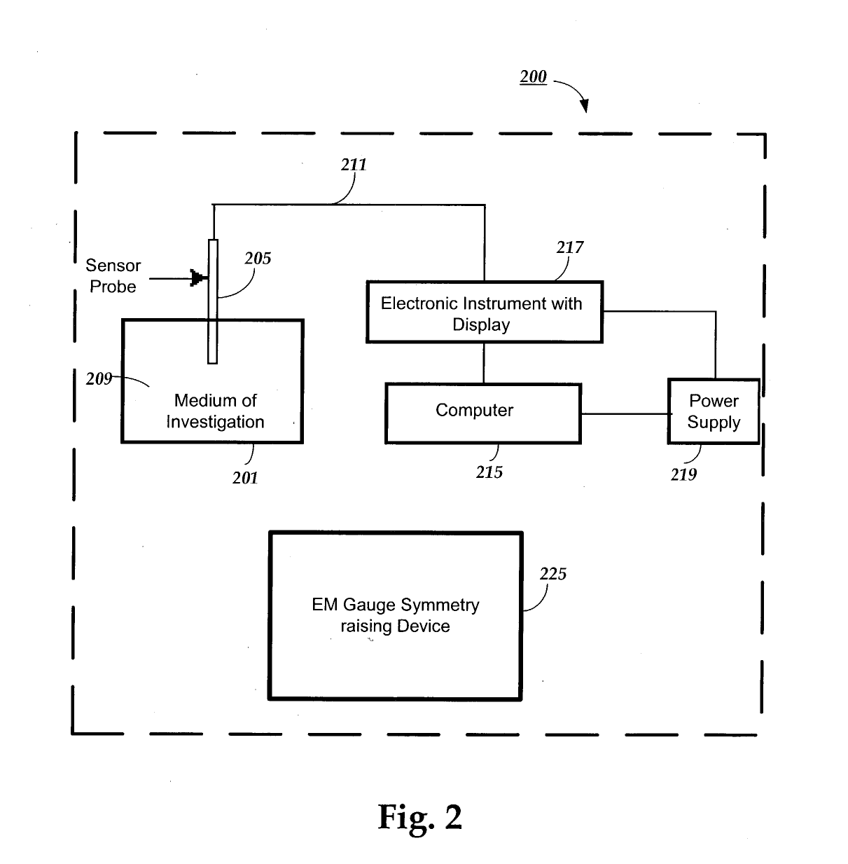

In yet another embodiment, an apparatus 200 for measuring the potential change, ΔΨ_{H}_{⁺}, associated with the symmetry change, as shown in FIG. 2, has a vessel or container 201 with a medium 209 of investigation such as purified water. The apparatus 200 further has a sensor probe 205, which contains both a pH electrode and a temperature probe and is coupled to an electronic display instrument 217 and a computer 215 through links 211. A power supply 219 is utilized to provide power to various devices. An EM gauge symmetry transforming device 225 transforms over time the symmetry state from the U(1) ground state to one of the possible higher symmetry states. A description of the device 225 is given in Reference 11, which is incorporated herein by reference in its entirety.

Again, a ThermoOrion® electrode is chosen as the sensor probe 205 and the SensorLink® measurement system made by Thermo Electron Corporation, 500 Cummings Center, Beverly, Mass. 01915-6199, is chosen, among other choices, as the computer 215 and the display 217. In operation, values of E, T_{w} and pH of medium 209 are continuously monitored by display 217 and computer 215 and data is continuously collected through probe 205 and computer 215. This data, plus a periodic calibration of the Nernst factor, S, using buffer solutions, allows both N and ΔΨ_{H}_{⁺} to be readily calculated and displayed. This time-varying display of ΔΨ_{H}_{⁺}(t) for a particular physical space is one aspect of the present invention.

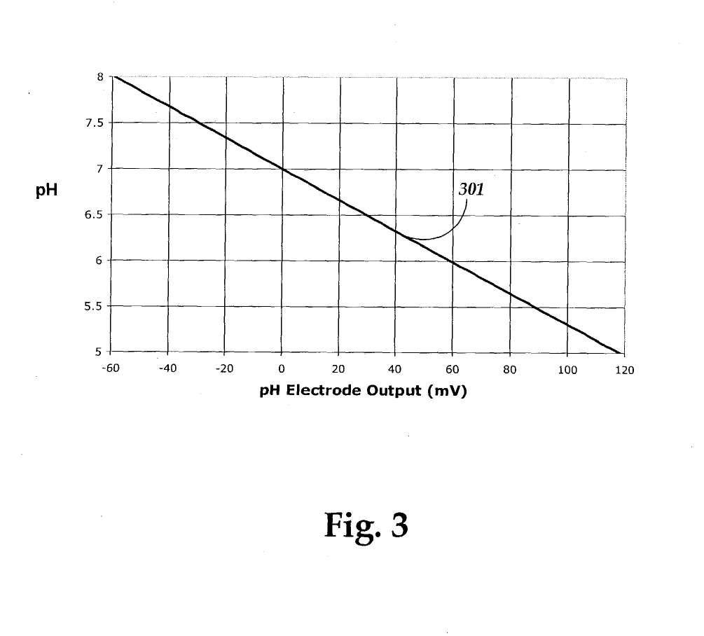

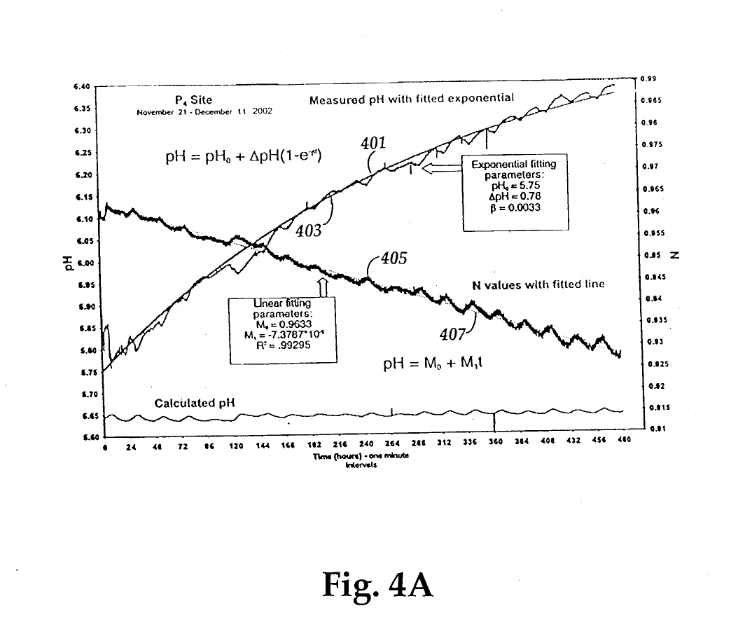

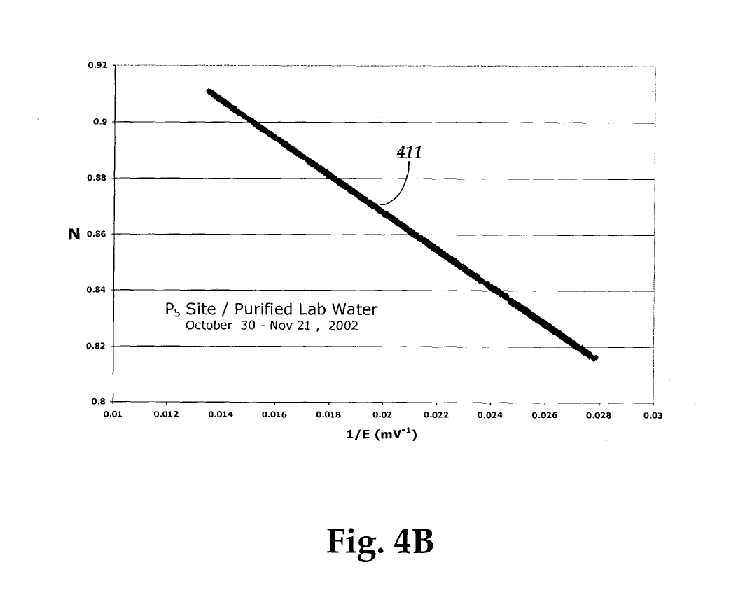

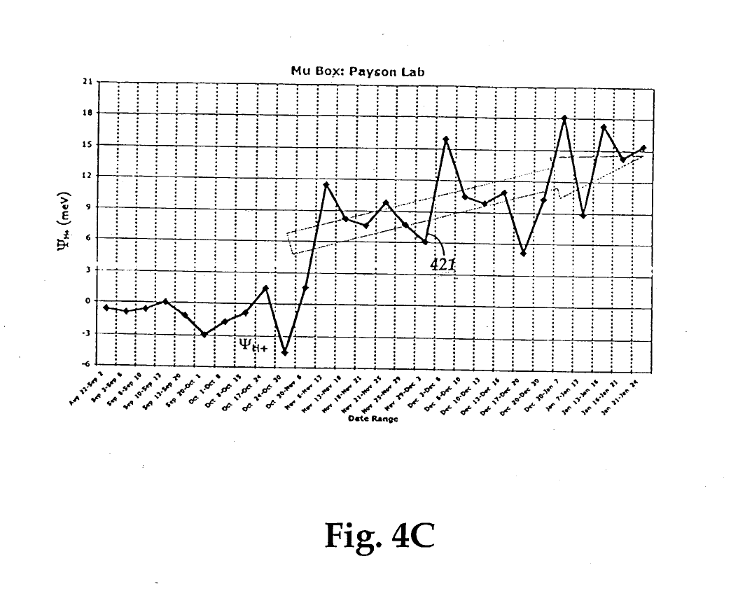

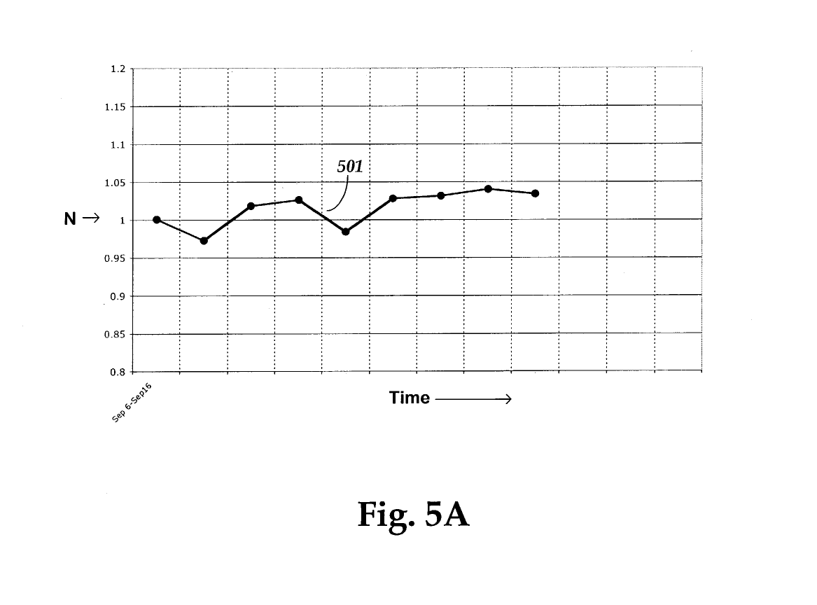

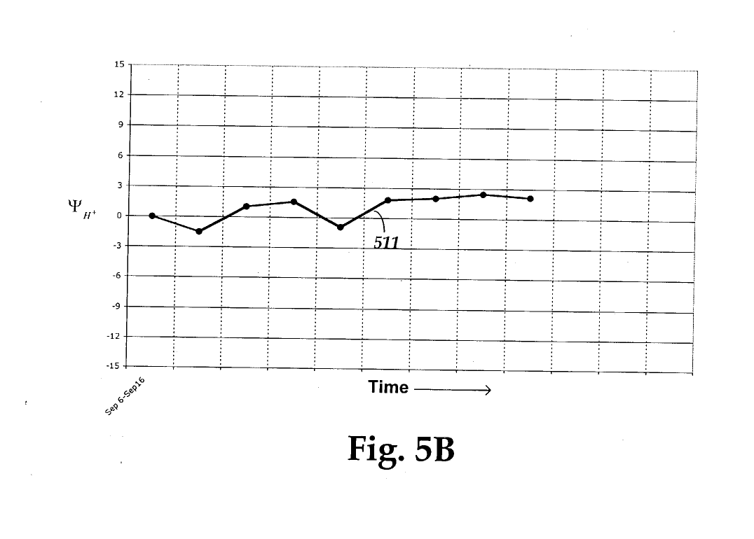

For an ideal pH electrode with slope efficiency of 100%, the calculated U(1) ground state relationship between pH and E at 25° C. is shown in FIG. 3 as curve 301, which, in fact, shows a linear relationship with a slope of −59.16 mv/pH unit. Additionally, as shown in FIG. 4A, measured pH(+) and N(t) curves 401, 405 are fitted with calculated curves 403, 407, respectively, showing an exponential relationship for curve 401 and linear relationship for curve 405. The curve 403 has the form of pH=pH₀+ΔpH(1−e^{-βt}), where pH₀=5.75, ΔpH=0.78, and βi=0.0033 as exponential fitting parameters. The curve 407 has the form of pH=M₀+M₁t, where M₀=0.9633 and M₁=−7.3787×10⁻⁵. Moreover, as shown in FIGS. 4B and 4C, respectively, curve 411 is measured N as a function of E⁻¹ and curve 421 is ΔΨ_{H}_{⁺} as a function of time. Furthermore, as shown in FIGS. 5A and 5B, curves 501, 511, respectively, show N(t) and ΔΨ_{H}_{⁺}(t) data at a different experimental site, before and after emplacement of EM Gauge symmetry-raising devices.

Moreover, values of ΔΨ_{H}_{⁺}=ΔΨ_{H}_{⁺}* when ΔN=1 for many of the various operating sites where the present inventions is practiced are provided in Table 1.

The foregoing demonstrates, among other things, that (1) this category of special device can indeed alter some environmental condition in a physical space so that it behaves lawfully but in an anomalous way compared to normal electrochemical behavior, (2) this anomalous behavior is consistent with the theoretical hypothesis that the EM Gauge symmetry state of the physical space has been raised above that of the standard U(1) Gauge state and (3) consistent with the analytical theory, a quantitative measurement of the thermodynamic magnetoelectrochemical potential change, Δ_{ΨH+}, for the aqueous solution-solvated hydrogen ion, H⁺, can be performed according to the present invention quantifying the symmetry change.

TABLE I
Values for Δψ_{H}_{⁺} = Δψ_{H}_{⁺} * (meV) when ΔN '2 1 for all of the various
sites operating in our overall experimental system.

| Site | Δψ_{H}_{⁺} * (meV) | Recent N-values | % departure from 1.00 |
|---|---|---|---|
| P₁ | 36.87 | .89 | 11 |
| P₂ | 65.0 | 1.14 | 14 |
| P₃ | 51.13 | .98 | 2 |
| P₄ | 54.22 | .87 | 13 |
| M | +11.25 | 1.3 | 30 |
| K | 76.0 | .98 | 2 |
| B_{A} | 20.85 | 1.23 | 23 |
| B_{B} | 59.84 | 1.04 | 4 |

In this Table, P = Payson, K '2 Kansas, M = Missouri, B_{A} = Baltimore and B_{B} = Bethesda and the subscript numbers stand for particular measurement stations located at these geographic sites as of ˜January 25, 2003.

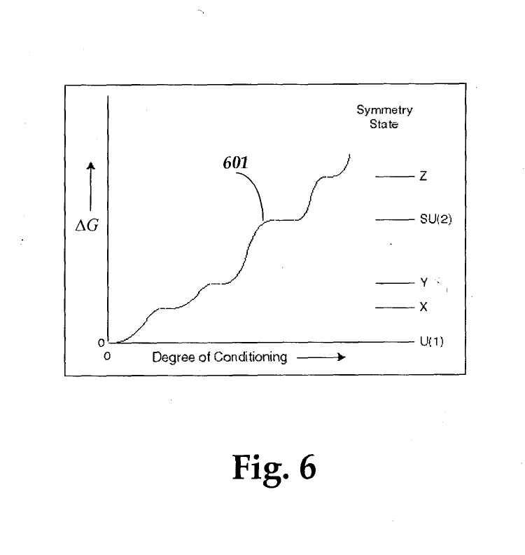

Thus, referring now to FIG. 6, as the laboratory space processing time with the presence of an apparatus 200 of the present invention, the space becomes “conditioned” to a higher EM Gauge symmetry level or state and the Gibbs Free Energy, G, or curve 601 in FIG. 6, increases accordingly. Postulating that this general type of behavior applies to all thermodynamic species, one sees that the locale symmetry state passes through the symmetries X, Y, SU(2) and Z as the degree of conditioning increases. Thus, one can say that the “conditioning” process according to the present invention stabilizes, in that space, a higher EM Gauge symmetry state than the U(1) symmetry state. This space then has a higher thermodynamic free energy than the surrounding U(1) Gauge state world and, with suitable linkages to that surrounding world, may deliver useful work to that U(1) EM Gauge domain because a thermodynamic free energy driving force exists between the two domains. It may therefore be via just such a process path that the experiments set forth above were able to produce, relative to U(1) Gauge state values, (1) significantly larger or smaller H⁺ concentrations in purified water, (2) significantly increased in vitro thermodynamic activity of a specific liver enzyme and (3) significantly increased in vivo ATP/ADP ratios in the cells of fruit fly larvae.

Accordingly, among other things, two discoveries were made and checked: (1) that a “conditioned” space, a higher EM Gauge symmetry space, constituted an important detector of one or more subtle energy perturbations in the environment and (2) if a single organ or system of the human body was elevated to one of these higher symmetry states at birth and the rest of the body was not, seemingly all functions of this body could be driven by this energy source to exhibit what one call life; i.e., the heart would pump blood, nerve synapses would switch on and off, electric currents would flow, the brain would be activated to direct various body processes, etc.

To further explore the first discovery, a simple experiment was conducted wherein three human subjects in need of treatment for chronic health challenges were studied over a single weekend in the Payson laboratory. One set up a treatment table in the laboratory upon which the subjects could be treated by a practitioner utilizing advanced kinesiology techniques to restore balance in various acupuncture meridian circuits of the subjects' bodies. At the same time, all the various aqueous physical chemistry monitoring stations in the laboratory were running continuously and computer monitored with no physical or electronic contact with the subjects. These stations were pH (several), oxygen solubility and cupric ion solubility and the subjects were treated one at a time for a period of about 2 to 4 hours each.

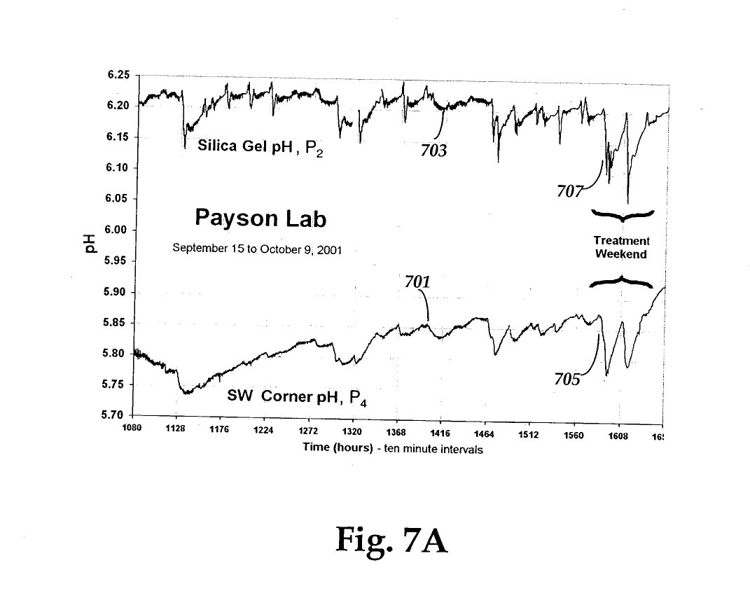

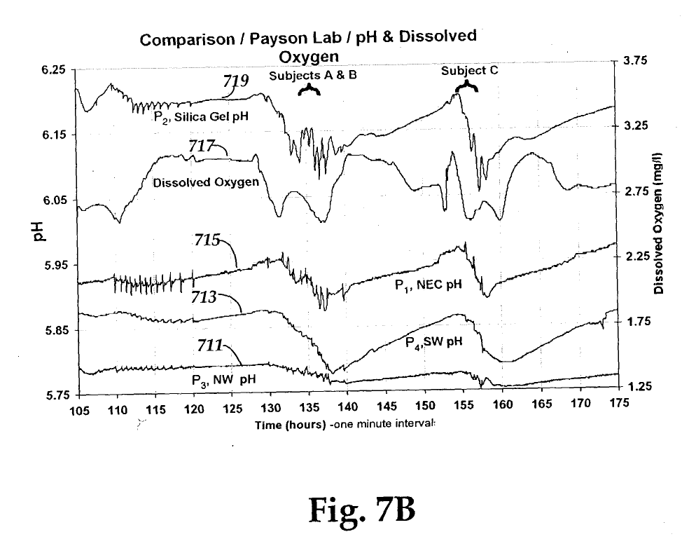

As shown in FIG. 7A, curves 701, 703 give observed pH variation for stations P₂ and P₄ in a 21-day period immediately preceding this treatment weekend plus the increase in amplitude of pH fluctuations at two stations during the treatment period, respectively. Moreover, as shown in FIG. 7B, at higher time resolution, curves 711, 713, 715, 717 and 719 give the pH and dissolved oxygen levels simultaneously measured at five separate locations in the laboratory, respectively. It was found that the onset, for examples, 705 of curve 701, or 767 of curve 703 of the first major pH drop occurred just before treatments began. Such precursor changes are not unusual in a “conditioned” laboratory space and are thought to represent changes in U(1)/SU(2) Gauge symmetry arising from the focused discussion prior to actually starting the experimental treatments. One can note from FIG. 7B how all the measurement stations responded in concert even though they were several meters away from each other and also from the treatment table.

To further explore the second discovery, technique from advanced kinesiology studies was utilized. There, a practitioner often slides a small DC magnet (with a central hole so it is washer-like with the N-pole on one face and a S-pole on the other) (not shown) onto the tip of his/her finger and, bringing this finger with the magnet into the biofield near a particular muscle group of a human subject or client, this can either strengthen or weaken the muscle group depending upon which pole points towards the muscle group. The S-pole facing the muscle group strengthens the muscle while the N-pole facing weakens the muscle's response. Since the normal U(1) EM Gauge symmetry state would not exhibit such a DC magnetic field polarity effect but the higher SU(2) EM Gauge symmetry state would, it indicates that the human acupuncture meridian/chakra system (which drives muscle response from a deeper level) is probably functioning from this SU(2) level while the majority of the rest of the physical body functions at the lower U(1) EM Gauge symmetry level. This means that EM force in humans, and perhaps all vertebrates, is quite different than the standard U(1) Gauge EM force.

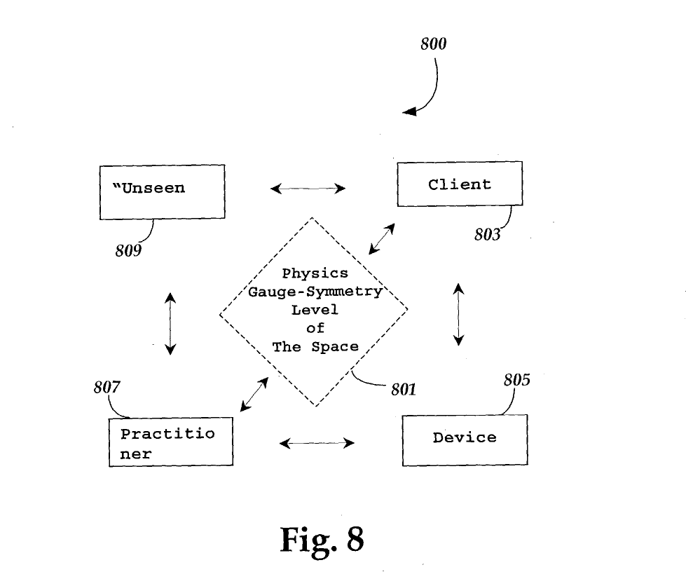

The foregoing disclosure indicates that a thermodynamic driving force may exist between the acupuncture meridian/chakra system and the coarse physical level of the body. This differential system can be labeled as a “chi/prana” pump causing the flow rate of such “fluids” through these subtle channels at the fine information wave level aspect of the physical body to be sufficient to nourish all of the terrain at the coarse particulate level of the physical body and thus manifest a satisfactory level of health. Following this line of reasoning, as shown in FIG. 8, how humans operate in life with respect to one another and how energy/consciousness emissions can occur when kinesiological manipulations of specific acupuncture meridians restore body balance by unblocking stagnated channels of chi/prana flow can be interpreted in a framework 800. Framework 800 provides channels for energy and, may be, consciousness exchange among elements of a client 803, a “conditioning” device 805, a practitioner 807, an “unseen universe” 809, and a physical space with a gauge symmetry state from which other elements operate. Whether one is a practitioner, a minister, a healer, a medical doctor or nurse, an acupuncturist, a kinesiologist, a performer, a spouse or a parent, Framework 800 provides an appropriate framework for energy/and consciousness exchange.

Thus, among other things, according to the present invention, first, material properties are EM Gauge symmetry specific; second, that all humans have their own chi/prana pump whereby, via focused intention, they may at least metastably raise the local EM Gauge symmetry state of their surrounding space; and thirdly, this can produce healings of great variety. Moreover, when an obstructed infrastructure circuit at some level of the body is restored to harmonious balance, a pulse of released energy/consciousness manifests and this complex signal may be detected by physical-type instruments that have been raised in functionality via being part of a laboratory space at a higher EM Gauge symmetry level than the normal U(1) symmetry state.

Without intend to limit the scope of the invention, further exemplary devices, methods and applications of the same according to the embodiments of the present invention are given below. Note that titles or subtitles may be used in the examples for convenience of a reader, which in no way should limit the scope of the invention.

### EXAMPLES

### Example One

In one embodiment of the present invention, a device 225 associated with an apparatus 200 or the like has been successfully and specially processed to broadcast (when turned on) a specific prime directive such as an information coded radiation to its local environment or physical space, will, over about a 2 to 4 month treatment period, cause the EM Gauge symmetry state of that space to be stably transformed to a higher level than the standard U(1) EM Gauge symmetry state. This physical space can be a laboratory, a hospital, a school, a professional's office, a home, a factory, an industrial plant, a resort as well as the interior of a moving vehicle like a car, airplane, ship, satellite, space vehicle, etc. The higher EM Gauge symmetry state, plus a prime directive imprint associated with the device used, activates a variety of natural processes in the local environment so as to manifest fulfillment of a particular prime directive in that environment. When not in use, the device with the particular prime directive can be stored in the off state inside an electrically grounded Faraday cage after having been first wrapped in metal films such as aluminum foil.

### Example Two

In another embodiment, the present invention relates to a procedure for instrumentally measuring a quantitative thermodynamic potential magnitude whereby the EM Gauge symmetry state of a particular space has been transformed from that of the U(1) Gauge symmetry state. This involves inserting a pH-measuring electrode and a temperature-measuring sensor into a vessel of water and continuously recording pH, E and T of the water. The recorded data with periodic calibration of the Nernst-factor, S, for the pH-measuring electrode allows continuous presentation of the Nernst-parameter as a function of time t, N(t), via Equation 8 as set forth above and thus continuous presentation of the changed proton magnetoelectrochemical potential, ΔΨ_{H}_{⁺}(t), from that for the U(1) EM Gauge symmetry state via Equation 10 as set forth above.

### Example Three

In yet another embodiment, the present invention relates to a computer program that can be executed in a CPU, as computer 215 does as shown in FIG. 2, for controlling and processing measurements of ΔΨ_{H}_{⁺}(t) and displaying ΔΨ_{H}_{⁺}(t) in either a stationary limited physical space or a moving limited physical space.

Moreover, as those skilled in the art will appreciate, this aspect of the present invention is capable of being distributed in the form of a computer readable medium of instructions in a variety of forms, and the present invention applies equally regardless of the particular type of signal bearing media used to actually carry out the distribution. Examples of computer readable media include: recordable type media such as floppy disks and CD-ROMs and transmission type media such as digital and analog communication links such as Internet. Note that the program can be written to be executed in a Unix operating system. Alternatively, it can be written to be executed in other operating systems such as Windows®, Apple®, etc.

### Example Four

In a further embodiment, the present invention relates to a method for measuring ΔΨ_{H}_{⁺}(t) at various locations adjacent to the body of a single human or a plurality of humans to indicate their degree of evolvement to the manifested higher EM Gauge symmetry states. The measurement in turn can be utilized in a biofeedback mode to quicken this rate of human evolvement if needed.

### Further Experimental Results and Implications

The present invention can find many more applications in a wide spectrum of fields as long as there is a presence of a confined physical space. Among them, some of the applications are given as examples as follows:

In Water Treatment: The present invention can be utilized (1) for sewage and waste disposal, (2) for scale reduction in boilers, (3) for agriculture (reduction in pesticide and fertilizer use), (4) for human consumption (to balance internal needs such as digestion, oxygen levels, etc., via activation of specific enzymes), and (5) for medical use in hospitals (intravenous infusions, nurseries, antiseptic cleansing, and the like).

In Chemical and Pharmaceutical Industries: The present invention can be utilized for shifting the yields of specific chemicals in different process reactions (isomer ratios, enantiomer ratios, and the like).

In Fuel Efficiency Enhancement: The present invention can be utilized for engines, furnaces, electric utilities, lighting, and the like that use gasoline, propane, natural gas, and the like.

In Transportation Industry: The present invention can be utilized (1) for automobiles, (2) for ships, (3) for aircraft and (4) for spacecraft (via tapping magnetic current and other special features of the vacuum).

In Electrical Industries: The present invention can be utilized (1) for raising the superconducting transition temperatures for materials by ordering their vacuum level, (2) semiconductor fabrication plants (by defect reduction and thus increased yields, etc.), (3) computers (by increased coherence, less noise and thus increased speed with fewer errors, etc.), (4) new energy sources (by tapping the magnetic currents of the vacuum state), and (5) electrochemical processing industry (by enhancing the efficiency of the electro-separation, electro-refining and deposition processes).

In Bulk and Film Crystal Growth Industries: The present invention can be utilized via ordering the vacuum state within the crystal.

In Professional Offices and Other Institutional spaces: The present invention can be utilized (1) by enhancing brain coherence in humans (education, sports, individuals, businesses, factories, military, hospital surgeries, and the like), (2) by enhancing cooperative human action in offices of psychologists, psychiatrists, lawyers, medical practitioners, and the like, and (3) replacing anesthetics during medical and dental procedures.

While there has been shown various embodiments of the present invention, it is to be understood that certain changes can be made in the form and arrangement of the elements of the system and steps of the methods to practice the present invention as would be known to one skilled in the art without departing from the underlying scope of the invention as is particularly set forth in the claims. Furthermore, the embodiments described above are only intended to illustrate the principles of the present invention and are not intended to limit the claims to the disclosed elements.

### LIST OF REFERENCES

1. K. Moriyasu, An Elementary Primer for Gauge Theory (World Scientific Publishing Co. Pte. Ltd., Singapore, 1983).

2. I. J. R. Aitchison and A. J. G. Hey, Gauge Theories in Particle Physics (Adam Hilger Ltd., Bristol, 1982).

3. H. A. Pohl, Dielectrophoresis (Cambridge University press, Cambridge, 1978).

4. T. B. Jones, Electromechanics of Particles (Cambridge University Press, New York, 1955).

5. J. W. Gibbs, The Collected Works, Vol. 1, 2nd Ed. (Yale University Press, New Haven, 1957).

6. R. A. Swalin, Thermodynamics of Solids (John Wiley & Sons, Inc., New York, 1962).

7. P. S. Epstein, Textbook of Thermodynamics (John Wiley & Sons, Inc., New York, 1937) CH. XVII.

8. H. Reiss, Methods of Thermodynamics (Blaisdell Publishing Co., Waltham, Mass., 1965).

9. W. E. Dibble, Jr. and W. A. Tiller, “Electronic Device-Mediated pH Changes in Water”, J. Sci. Expl. 13 (1999) 155-176.

10. W. A. Tiller and W. E. Dibble, Jr., “New Experimental Data Revealing an Unexpected Dimesion to Materials Science and Engineering”, Mat. Res. Innovat. 5 (2001) 21-34.

11. W. A. Tiller, W. E. Dibble, Jr., and M. J. Kobane, Conscious Acts of Creation: The Emergence of a New Physics (Pavior Publishing, Walnut Creek, Calif., 2001).

12. Tiller, W. A., “What are Subtle Energies?” Journal of Scientific Exploration, 7 (1993)

13. G. T. Goodheart, Jr., Applied Kinesiology (Privately Published, Detroit, Mich., 1964).

14. D. S. Walther, Applied Kinesiology, Vol. I (SDC Systems DC, Pueblo, Colo., 1981).

15. C. T. Krebs, Ch. 2 in A Revolutionary Way of Thinking (Hill of Content, Melbourne, Australia, 1998).

What is claimed is:

1. An apparatus for measuring a thermodynamic potential Ψ of a limited physical space, wherein the limited physical space is characterized by a series of symmetry states having a ground symmetry state and at least one higher symmetry state, comprising:
(a) a container at least partially filled with a liquid and placed within the limited physical space, wherein liquid is characterized by a parameter related to the hydrogen-ion activity, pH;
(b) a reference electrode with an input end and an output end;
(c) a measurement electrode with an input end and an output end, wherein the input end of the reference electrode and the input end of the measurement electrode are placed in the liquid for measuring the potential between the reference electrode and the measurement electrode, E_{measured}, as a function of time, from which the pH of the liquid as a function of time can be obtained;
(d) a microprocessor operatively coupled to the output end of the reference electrode and the output end of the measurement electrode, respectively, for receiving and processing the measured potential to obtain the change in the thermodynamic potential Ψ of the limited physical space; and
(e) a power supply operatively coupled to the reference electrode, the measurement electrode, and the microprocessor, respectively, for supplying power.

2. The apparatus of claim 1, further comprising a temperature measuring sensor for measuring temperature, T, of the liquid as a function of time.

3. The apparatus of claim 2, wherein the microprocessor performs the step of obtaining the change in the thermodynamic potential Ψ of the limited physical space, ΔΨ_{H}_{⁺}, from a relation having the form of:
ΔΨ_{H}_{⁺}=|e|E(1−|N|)
wherein e is electron charge, E is a potential function between the reference electrode and the measurement electrode with the U(1) ground state form of
E=S(pH−7)((T+273.15)/298.15)
wherein E is in the unit of millivolts, T is in the unit of ° C., and N is an Nernst parameter, with the form of
$$N = \frac{S}{E} ( pH - 7 ) ( \frac{T + 273.15}{298.15} ) .$$

4. The apparatus of claim 3, wherein the electrode slope S is determined from a relation having the form of:
S=dE_{measured}/dpH.

5. The apparatus of claim 3, wherein the Nernst parameter, N, has a value of unity for the limited physical space at its ground symmetry state.

6. The apparatus of claim 5, wherein the Nernst parameter, N, has a value of non-unity for the limited physical space at its at least one higher symmetry state.

7. The apparatus of claim 5, wherein the ground symmetry state is characterized by a U(1) EM Gauge symmetry.

8. The apparatus of claim 5, wherein the at least one higher symmetry state is characterized by a symmetry that is not a U(1) EM Gauge symmetry.

9. The apparatus of claim 8, wherein the at least one higher symmetry state is characterized by an SU(2) symmetry.

10. The apparatus of claim 1, wherein the liquid comprises water.

11. The apparatus of claim 1, further comprising means for calibrating the reference electrode and the measurement electrode with at least two pH buffer solutions.

12. The apparatus of claim 1, wherein the thermodynamic potential Ψ comprises a proton magnetoelectrochemical potential.

13. The apparatus of claim 1, wherein the limited physical space comprises a space substantially confined in three dimensions.

14. The apparatus of claim 13, wherein the confined space comprises the interior space confined by a stationary structure.

15. The apparatus of claim 13, wherein the confined space comprises the interior space confined by a structure that is stationary or in motion.

16. The apparatus of claim 1, further comprising a display device that is operatively coupled at least to the microprocessor and the power supply, respectively.

17. A method for changing a thermodynamic potential of a limited physical space, wherein the limited physical space is characterized by a series of symmetry states having a ground symmetry state and at least one higher symmetry state, comprising the step of:
(a) transforming the limited physical space from the ground symmetry state to a higher symmetry state to cause the thermodynamic potential of the limited physical space to change from a first value to a second value.

18. The method of claim 7, wherein the ground symmetry state is a U(1) EM Gauge symmetry state.

19. The method of claim 18, wherein the at least one higher symmetry state is characterized by a symmetry that is not a U(1) EM Gauge symmetry.

20. The method of claim 18, wherein the at least one higher symmetry state is characterized by an SU(2) symmetry.

21. The method of claim 17, wherein the thermodynamic potential comprises a proton magnetoelectrochemical potential.

22. The method of claim 17, wherein the transforming step comprises the step of:
(1) conditioning the limited physical space with an information encoded radiation that is capable of causing the symmetry state of the limited physical space to change.

23. The method of claim 22, wherein the information encoded radiation comprises a magnetic field signal.

24. The method of claim 22, wherein the information encoded radiation comprises an electric field signal.

25. The method of claim 17, wherein the limited physical space comprises a space substantially confined in three dimensions.

26. The method of claim 25, wherein the confined space comprises the interior space confined by a stationary structure.

27. The method of claim 25, wherein the confined space comprises the interior space confined by a structure that is stationary or in motion.

28. The method of claim 17, further comprising the steps of:
(b) maintaining the limited physical space at the higher symmetry state with the second value of the thermodynamic potential; and
(c) monitoring response of an object in the limited physical space at the higher symmetry state so as to provide feedback to the maintaining step.

29. The method of claim 28, wherein the object in the limited physical space comprises at least one of a biological object and a non-biological object.

30. An apparatus for changing a thermodynamic potential of a limited physical space, wherein the limited physical space is characterized by a series of symmetry states having a ground symmetry state and at least one higher symmetry state, comprising:
(a) means for transforming the limited physical space from the ground symmetry state to a higher symmetry state to cause the thermodynamic potential of the limited physical space to change from a first value to a second value.

31. The apparatus of claim 30, wherein the ground symmetry state is a U(1) EM Gauge symmetry state.

32. The apparatus of claim 31, wherein the at least one higher symmetry state is characterized by a symmetry that is not a U(1) EM Gauge symmetry.

33. The apparatus of claim 31, wherein the at least one higher symmetry state is characterized by an SU(2) symmetry.

34. The apparatus of claim 30, wherein the thermodynamic potential comprises a proton magnetoelectrochemical potential.

35. The apparatus of claim 30, wherein the transforming means comprises:
(1) means for conditioning the limited physical space with an information encoded radiation that is capable of causing the symmetry state of the limited physical space to change.

36. The apparatus of claim 35, wherein the information encoded radiation comprises a magnetic field signal.

37. The apparatus of claim 35, wherein the information encoded radiation comprises an electric field signal.

38. The apparatus of claim 30, wherein the limited physical space comprises a space substantially confined in three dimensions.

39. The apparatus of claim 38, wherein the limited physical space comprises the interior space confined by a stationary structure.

40. The apparatus of claim 38, wherein the limited physical space comprises the interior space confined by a structure that is stationary or in motion.

41. The apparatus of claim 30, further comprising:
(b) means for maintaining the limited physical space at the higher symmetry state with the second value of the thermodynamic potential; and
(c) means for monitoring response of an object in the limited physical space at the higher symmetry state so as to provide feedback to the maintaining means.

42. The apparatus of claim 41, wherein the object in the limited physical space comprises at least one of a biological object and a non-biological object.

43. A method for measuring a thermodynamic potential Ψ of a limited physical space, wherein the limited physical space is characterized by a series of symmetry states having a ground symmetry state with a corresponding first value and at least one higher symmetry state with a corresponding second value, comprising the steps of:
(a) placing a container at least partially filled with a liquid within the limited physical space, wherein liquid is characterized by a parameter related to the hydrogen-ion activity, pH;
(b) inserting a reference electrode and a measurement electrode into the liquid;
(c) measuring the potential between the reference electrode and the measurement electrode, E_{measured}, as a function of time;
(d) measuring the pH of the liquid as a function of time;
(e) measuring temperature, T, of the liquid as a function of time;
(f) determining the electrode slope, S, for the liquid;
(g) introducing a potential function between the reference electrode and the measurement electrode, E, having the U(1) ground state form of
E=S(pH−7)((T+273.15)/298.15)
wherein T is in the unit of ° C., and E is in the unit of millivolts;
(h) introducing an Nernst parameter, N, having the form of
$$N = \frac{S}{E} ( pH - 7 ) ( \frac{T + 273.15}{298.15} ) ;$$
and
(i) obtaining the change in the thermodynamic potential Ψ of the limited physical space, ΔΨ_{H}_{⁺}, from a relation having the form of:
ΔΨ_{H}_{⁺}=eE(1−|N|)
wherein e is electron charge.

44. The method of claim 43, wherein the liquid comprises water.

45. The method of claim 43, wherein the medium is a gel electrolyte.

46. The method of claim 43, wherein the medium is a solid state electrolyte.

47. The method of claim 43, wherein the step of determining the electrode slope S comprises the step of calculating S from a relation having the form of:
S=dE_{measured}/dpH.

48. The method of claim 47, further comprising the step of calibrating the reference electrode and the measurement electrode with at least two pH buffer solutions.

49. The method of claim 43, wherein the thermodynamic potential Ψ comprises a proton magnetoelectrochemical potential.

50. The method of claim 43, wherein the Nernst parameter, N, has a value of unity for the limited physical space at its ground symmetry state.

51. The method of claim 50, wherein the Nernst parameter, N, has a value of non-unity for the limited physical space at its at least one higher symmetry state.

52. The method of claim 51, wherein the ground symmetry state is characterized by a U(1) EM Gauge symmetry.

53. The method of claim 51, wherein the at least one higher symmetry state is characterized by a symmetry that is not a U(1) EM Gauge symmetry.

54. The method of claim 53, wherein the at least one higher symmetry state is characterized by an SU(2) symmetry.

55. The method of claim 43, wherein the limited physical space comprises a space substantially confined in three dimensions.

56. The method of claim 43, wherein the confined space comprises the interior space confined by a stationary structure.

57. The method of claim 43, wherein the confined space comprises the interior space confined by a structure that is stationary or in motion.

58. An apparatus for measuring a thermodynamic potential Ψ of a limited physical space, wherein the limited physical space is characterized by a series of symmetry states having a ground symmetry state with a corresponding first value and at least one higher symmetry state with a corresponding second value, comprising:
(a) a container at least partially filled with a liquid placed within the limited physical space, wherein liquid is characterized by a parameter related to the hydrogen-ion activity, pH;
(b) a reference electrode and a measurement electrode placed in the liquid for measuring the potential between the reference electrode and the measurement electrode, E_{measured}, as a function of time, from which the pH of the liquid as a function of time can be obtained;
(c) means for measuring temperature, T, of the liquid as a function of time;
(d) means for determining the electrode slope, S, for the liquid;
(e) means for obtaining the change in the thermodynamic potential Ψ of the limited physical space, ΔΨ_{H}_{⁺}, from a relation having the form of:
ΔΨ_{H}_{⁺}=|e|E(1−|N|)
wherein e is electron charge, E is a potential function between the reference electrode and the measurement electrode with the form of
E=S(pH−7)((T+273.15)/298.15)
E is in the unit of millivolts, T is in the unit of ° C., and N is an Nernst parameter, with the form of
$$N = \frac{S}{E} ( pH - 7 ) ( \frac{T + 273.15}{298.15} ) .$$

59. The apparatus of claim 58, wherein the liquid comprises water.

60. The apparatus of claim 58, wherein the medium comprises a gel electrolyte.

61. The apparatus of claim 58, wherein the medium comprises a solid state electrolyte.

62. The apparatus of claim 58, wherein the electrode slope S is determined from a relation having the form of:
S=dE_{measured}/dpH.

63. The apparatus of claim 58, further comprising means for calibrating the reference electrode and the measurement electrode with at least two pH buffer solutions.

64. The apparatus of claim 58, wherein the thermodynamic potential Ψ comprises a proton magnetoelectrochemical potential.

65. The apparatus of claim 58, wherein the Nernst parameter, N, has a value of unity for the limited physical space at its ground symmetry state.

66. The apparatus of claim 65, wherein the Nernst parameter, N, has a value of non-unity for the limited physical space at its at least one higher symmetry state.

67. The apparatus of claim 65, wherein the ground symmetry state is characterized by a U(1) EM Gauge symmetry.

68. The apparatus of claim 65, wherein the at least one higher symmetry state is characterized by a symmetry that is not a U(1) EM Gauge symmetry.

69. The apparatus of claim 65, wherein the at least one higher symmetry state is characterized by an SU(2) symmetry.

70. The apparatus of claim 58, wherein the limited physical space comprises a space substantially confined in three dimensions.

71. The apparatus of claim 70, wherein the confined space comprises the interior space confined by a stationary structure.

72. The apparatus of claim 70, wherein the confined space comprises the interior space confined by a structure that is stationary or in motion.

73. The apparatus of claim 58, wherein the means for measuring temperature comprises a temperature measuring sensor.

74. The apparatus of claim 58, wherein the means for obtaining the change in the thermodynamic potential Ψ of the limited physical space comprises a microprocessor.

75. The apparatus of claim 74, further comprising a power supply that is operatively coupled to the reference electrode, the measurement electrode, and the microprocessor, respectively.

76. The apparatus of claim 75, further comprising a display device that is operatively coupled at least to the microprocessor and the power supply, respectively.
